(19) United States
(12) Patent Application Publication
(10) Pub. No.: US 2018/0309715 A1
(43) Pub. Date: Oct. 25, 2018

(54) ADDRESS ASSIGNMENT METHOD, GATEWAY, AND SYSTEM

(71) Applicant: Huawei Technologies Co., Ltd., Shenzhen (CN)

(72) Inventors: Dong Li, Shanghai (CN); Han Zhou, Shanghai (CN); Jian Xu, Shenzhen (CN); Jianwei Sun, Beijing (CN); Xiaodong Sun, Beijing (CN); Yan Su, Beijing (CN)

(21) Appl. No.: 16/024,570

(22) Filed: Jun. 29, 2018

Related U.S. Application Data
(63) Continuation of application No. PCT/CN2016/109048, filed on Dec. 8, 2016.

(30) Foreign Application Priority Data
Dec. 31, 2015 (CN) 201511030225.2

(51) Int. Cl. H04L 29/12

(52) U.S. Cl. CPC H04L 61/2015; H04L 61/6013; H04L 61/2061

(57) ABSTRACT

The present disclosure discloses an address assignment method, a gateway, and a system. The method includes: obtaining, by a control network element, first weight information of a first distributed gateway DGW, and assigning a first address segment to the first DGW according to the first weight information; and sending, by the control network element, address segment information of the first address segment to the first DGW. Proper address segment assignment is implemented, and address resource utilization is improved.

### CROSS-REFERENCE TO RELATED APPLICATIONS

This application is a continuation of International Application No. PCT/CN2016/109048, filed on Dec. 8, 2016, which claims priority to Chinese Patent Application No. 201511030225.2, filed on Dec. 31, 2015. The disclosures of the aforementioned applications are hereby incorporated by reference in their entireties.

### TECHNICAL FIELD

The present application relates to the field of wireless communications technologies, and in particular, to an address assignment method, a gateway, and a system.

### BACKGROUND

After a conventional gateway is separated into a control plane gateway (CGW) and a distributed gateway (DGW), the CGW is responsible for delivering control signaling, scheduling address assignment for a managed DGW, and assigning an Internet Protocol (IP) address to a terminal device; and the DGW is responsible for data transmission. Currently, the following two technical solutions are mainly used for address assignment and address management for a terminal device:

In a first solution, user access signaling in a distributed gateway is mainly processed by a CGW; the CGW defines a function and defines a user plane data processing manner for a DGW by using an S18 interface; the CGW assigns addresses to all terminal devices and manages all the addresses in a centralized manner; and the DGW maintains no address, and only needs to maintain and publish routing information of a current terminal device, so that another device can locate the terminal device. However, because an IP address is randomly and disorderly assigned to the terminal device, and the CGW manages a relatively large quantity of DGWs, when a quantity of terminal devices increases, a case in which IP addresses of many terminal devices belonging to one DGW respectively belong to different network segments may occur. In addition, the DGW needs to maintain routing information of the terminal devices at the same time. When the quantity of terminal devices continues to increase, a case in which IP addresses of terminal devices in a same network segment belong to different DGWs may further occur. Consequently, the DGW needs to maintain a plurality of routing tables, greatly reducing running efficiency of an entire link, and increasing network complexity. This may be uncontrollable.

In a second solution, a DGW assigns addresses to all terminal devices and manages the addresses of the terminal devices in a centralized manner, and maintains routing notifications of managed terminal devices. After a relatively large quantity of terminal devices are successfully attached, the terminal devices are attached to DGWs to which the terminal devices respectively belong. However, because there is no signaling exchanged between DGWs, when too many terminal devices cause an increase in load of a DGW, the DGW cannot perform a load balancing operation with a surrounding idle DGW. Consequently, a terminal device that requests attachment subsequently cannot be successfully attached, and address segment resource utilization of an entire system is reduced.

Neither of the foregoing two solutions can implement proper and dynamic address resource assignment.

### SUMMARY

The present disclosure provides an address assignment method, a gateway, and a system, so as to resolve a problem of relatively low link utilization that is caused by improper address assignment by a DGW in an existing mechanism.

A first aspect of the present disclosure provides an address assignment method. The method includes:

obtaining, by a control network element, first weight information of a first distributed gateway DGW, and assigning a first address segment to the first DGW according to the first weight information; and sending, by the control network element, address segment information of the first address segment to the first DGW.

In some possible designs, the method further includes:

receiving, by the control network element, a first message sent by a mobility management entity MME, where the first message is used to indicate that a terminal device requests to obtain an Internet Protocol IP address; and

obtaining, by the control network element, a destination IP address assigned by the first DGW to the terminal device, and returning, to the MME, a second message carrying the destination IP address.

In some possible designs, the obtaining, by the control network element, a destination IP address assigned by the first DGW to the terminal device, and returning, to the MME, a second message carrying the destination IP address includes one of the following:

if it is the first time that the first DGW assigns an IP address to the terminal device after the first DGW is powered on, adding, by the control network element, a starting address of the first address segment as the destination IP address to the second message, and returning the second message to the MME; or

if it is not the first time that the first DGW assigns an IP address, sending, by the control network element, a third message to the first DGW, where the third message is used to instruct the first DGW to assign the destination IP address to the terminal device; and after receiving a fourth message that is returned by the first DGW and that carries the destination IP address, returning, by the control network element to the MME, the second message carrying the destination IP address.

In some possible designs, for example, in a scenario with a DHCP server, the address segment information of the first address segment includes an identifier of the first address segment; and after the assigning a first address segment to the first DGW according to the first weight information, the method further includes:

sending, by the control network element, the address segment information of the first address segment to the Dynamic Host Configuration Protocol DHCP server, so that the DHCP server specifies the first address segment in an address resource pool according to the address segment information of the first address segment.

In some possible designs, the method further includes one of the following:

obtaining, by the control network element, the identifier of the first address segment from the DHCP server, and after receiving a first request message sent by the MME, obtaining, from the DHCP server according to the identifier of the first address segment, the destination IP address assigned to the terminal device, and returning the destination IP address to the MME; or

obtaining, by the control network element, the identifier of the first address segment from the DHCP server, and sending the identifier of the first address segment to the first DGW, so that after receiving a fifth message sent by the terminal device, the first DGW obtains, from the DHCP server according to the identifier of the first address segment, the destination IP address assigned to the terminal device, and returns the destination IP address to the terminal device.

In some possible designs, the control network element includes a control plane gateway CGW and an operation management OM entity; the first address segment is assigned by the OM entity to the first DGW according to the first weight information; the address segment information of the first address segment is sent by the OM entity to the DHCP server; the identifier of the first address segment is obtained by the OM entity from the DHCP server; and the first weight information is obtained by the CGW from the first DGW.

In some possible designs, the identifier of the first address segment includes a proxy IP address of the DHCP server or a starting address of the first address segment.

In some possible designs, the method further includes:

when determining that there is an idle address segment in the first address segment, performing, by the control network element, at least one of the following:

releasing the idle address segment; or

assigning the idle address segment to a DGW that is managed by the control network element and that has an urgent address requirement; or

re-assigning a new address segment to the first DGW according to address usage of the first DGW.

In some possible designs, the method further includes:

obtaining, by the control network element, second weight information of a second DGW, and when determining that a remaining address segment resource in address segment resources is insufficient to assign an address segment corresponding to the second weight information, and there is the idle address segment in the first address segment, releasing the idle address segment in the first address segment, and assigning the idle address segment in the first address segment to the second DGW.

In some possible designs, the method further includes one of the following:

periodically obtaining, by the control network element, usage of address segments of all managed DGWs, and when determining that a preset update triggering condition is satisfied, re-assigning new address segments to some or all of the managed DGWs according to the usage of the address segments of all the managed DGWs;

obtaining, by the control network element, usage of address segments of all managed DGWs before a preset congestion time period is reached, and when determining that a preset update triggering condition is satisfied, re-assigning new address segments to some or all of the managed DGWs according to the usage of the address segments of all the managed DGWs;

receiving, by the control network element, a sixth message sent by the first DGW, and assigning a new address segment to the first DGW according to the sixth message;

obtaining, by the control network element, new weight information of the first DGW, and re-assigning a new address segment to the first DGW according to the new weight information; or

after being reset or recovered from a fault, receiving and storing, by the control network element, usage of the first address segment that is sent by the first DGW.

In some possible designs, the assigning, by a control network element, a first address segment to the first DGW according to the first weight information, and the obtaining, by the control network element, the identifier of the first address segment from the DHCP server, and sending the identifier of the first address segment to the first DGW specifically include:

obtaining, by the CGW in the control network element, the first weight information of the first DGW, and sending the first weight information to the OM entity in the control network element;

assigning, by the OM entity in the control network element, the first address segment to the first DGW in the DHCP server according to the first weight information, and sending the identifier of the first address segment that is obtained from the DHCP server to the CGW; and

sending, by the CGW in the control network element, the received identifier of the first address segment to the first DGW, so that after receiving a second request message sent by the terminal device, the first DGW obtains, from the DHCP server according to the identifier of the first address segment, the destination IP address assigned to the terminal device, and returns the destination IP address to the terminal device.

A second aspect of this application provides an address assignment method. The method includes:

sending, by a first distributed gateway DGW, first weight information of the first DGW to a control network element, so that the control network element assigns a corresponding first address segment to the first DGW according to the first weight information; and

receiving, by the first DGW, address segment information of the first address segment that is returned by the control network element.

In some possible designs, the method further includes:

receiving, by the first DGW, a third message sent by the control network element, assigning a destination IP address to a terminal device according to the third message, and sending, to the control network element, a fourth message carrying the destination IP address, so that the control network element adds the destination IP address to a second message and returns the second message to a mobility management entity MME.

In some possible designs, the method further includes:

after receiving a fifth message sent by the terminal device, obtaining, by the first DGW from the DHCP server according to an identifier of the first address segment, the destination IP address assigned to the terminal device, and returning the destination IP address to the terminal device.

In some possible designs, the address segment information of the first address segment includes the identifier of the first address segment, and the identifier of the first address segment includes a proxy IP address of the DHCP server or a starting address of the first address segment.

In some possible designs, the method further includes one of the following:

periodically sending, by the first DGW, usage of the first address segment to the control network element, so that when determining that there is an idle address segment in the first address segment, the control network element releases the idle address segment, or assigns the idle address segment to a DGW that is managed by the control network element and that has an urgent address requirement, or re-assigns a new address segment to the first DGW according to address usage of the first DGW;

sending, by the first DGW, a sixth message to the control network element, where the sixth message is used to request the control network element to assign a new address segment to the first DGW;

after the control network element is reset or recovered from a fault, sending, by the first DGW, usage of the first address segment to the control network element; or

periodically counting, by the first DGW, a quantity of terminal devices accessing the first DGW, and when determining that the first address segment cannot meet a requirement of the terminal device, sending new weight information to the control network element, so that the control network element re-assigns a new address segment to the first DGW.

A third aspect of this application provides a control network element. The control network element includes:

a receiving module, configured to obtain first weight information of a first distributed gateway DGW;

a processing module, configured to assign a first address segment to the first DGW according to the first weight information received by the receiving module; and

a sending module, configured to send address segment information of the first address segment to the first DGW.

In some possible designs, the receiving module is further configured to: receive a first message sent by a mobility management entity MME, where the first message is used to indicate that a terminal device requests to obtain an Internet Protocol IP address; and obtain a destination IP address assigned by the first DGW to the terminal device; and

the sending module is further configured to return, to the MME, a second message carrying the destination IP address obtained by the receiving module.

In some possible designs, the processing module is further configured to perform one of the following:

if it is the first time that the first DGW assigns an IP address to the terminal device after the first DGW is powered on, adding a starting address of the first address segment as the destination IP address to the second message, and returning the second message to the MME by using the sending module; or

if it is not the first time that the first DGW assigns an IP address, sending a third message to the first DGW by using the sending module, where the third message is used to instruct the first DGW to assign the destination IP address to the terminal device; and after receiving, by using the receiving module, a fourth message that is returned by the first DGW and that carries the destination IP address, returning, to the MME by using the sending module, the second message carrying the destination IP address.

In some possible designs, the address segment information of the first address segment includes an identifier of the first address segment, and the sending module is further configured to:

send the address segment information of the first address segment to a Dynamic Host Configuration Protocol DHCP server, so that the DHCP server specifies the first address segment in an address resource pool according to the address segment information of the first address segment.

In some possible designs, the processing module is further configured to perform one of the following steps:

obtaining the identifier of the first address segment from the DHCP server by using the receiving module, and after receiving, by using the receiving module, a first request message sent by the MME, obtaining, from the DHCP server according to the identifier of the first address segment, the destination IP address assigned to the terminal device, and returning the destination IP address to the MME by using the sending module; or

obtaining the identifier of the first address segment from the DHCP server by using the receiving module, and sending the identifier of the first address segment to the first DGW by using the sending module, so that after receiving a fifth message sent by the terminal device, the first DGW obtains, from the DHCP server according to the identifier of the first address segment, the destination IP address assigned to the terminal device, and returns the destination IP address to the terminal device.

In some possible designs, the identifier of the first address segment includes a proxy IP address of the DHCP server or a starting address of the first address segment.

In some possible designs, when determining that there is an idle address segment in the first address segment, the processing module is further configured to perform at least one of the following:

releasing the idle address segment; or

assigning the idle address segment to a DGW that is managed by the control network element and that has an urgent address requirement; or

re-assigning a new address segment to the first DGW according to address usage of the first DGW.

In some possible designs, the processing module is further configured to:

obtain, by using the receiving module, second weight information of a second DGW, and when determining that a remaining address segment resource in address segment resources is insufficient to assign an address segment corresponding to the second weight information, and there is the idle address segment in the first address segment, release the idle address segment in the first address segment, and assign the idle address segment in the first address segment to the second DGW.

In some possible designs, the processing module is further configured to perform one of the following steps:

periodically obtaining, by using the receiving module, usage of address segments of all managed DGWs, and when determining that a preset update triggering condition is satisfied, re-assigning new address segments to some or all of the managed DGWs according to the usage of the address segments of all the managed DGWs;

obtaining, by using the receiving module, usage of address segments of all managed DGWs before a preset congestion time period is reached, and when determining that a preset update triggering condition is satisfied, re-assigning new address segments to some or all of the managed DGWs according to the usage of the address segments of all the managed DGWs;

receiving, by using the receiving module, a sixth message sent by the first DGW, and assigning a new address segment to the first DGW according to the sixth message;

obtaining, by using the receiving module, new weight information of the first DGW, and re-assigning a new address segment to the first DGW according to the new weight information; or

after the control network element is reset or recovered from a fault, receiving and storing, by using the receiving module, usage of the first address segment that is sent by the first DGW.

The control network element has a function of implementing an action of the control network element in the foregoing method designs. The function may be implemented by hardware, or may be implemented by executing corresponding software by hardware. The hardware or software includes one or more modules corresponding to the foregoing function. The module may be software and/or hardware.

A fourth aspect of the present disclosure provides a first distributed gateway. The first distributed gateway includes:

a sending module, configured to send first weight information of the first distributed gateway to a control network element, so that the control network element assigns a corresponding first address segment to the first DGW according to the first weight information; and

a receiving module, configured to receive address segment information of the first address segment that is returned by the control network element.

In some possible designs, the first distributed gateway further includes:

a processing module, configured to: receive, by using the receiving module, a third message sent by the control network element, assign a destination IP address to a terminal device according to the third message, and send, to the control network element by using the sending module, a fourth message carrying the destination IP address, so that the control network element adds the destination IP address to a second message and returns the second message to a mobility management entity MME.

In some possible designs, the processing module is further configured to:

after receiving, by using the receiving module, a fifth message sent by the terminal device, obtain, from a DHCP server according to an identifier of the first address segment, the destination IP address assigned to the terminal device, and return the destination IP address to the terminal device by using the sending module.

In some possible designs, the address segment information of the first address segment includes the identifier of the first address segment, and the identifier of the first address segment includes a proxy IP address of the DHCP server or a starting address of the first address segment.

In some possible designs, the processing module is further configured to perform one of the following:

periodically sending usage of the first address segment to the control network element by using the sending module, so that when determining that there is an idle address segment in the first address segment, the control network element releases the idle address segment, or assigns the idle address segment to a DGW that is managed by the control network element and that has an urgent address requirement, or re-assigns a new address segment to the first DGW according to address usage of the first DGW;

sending a sixth message to the control network element by using the sending module, where the sixth message is used to request the control network element to assign a new address segment to the first DGW;

after the control network element is reset or recovered from a fault, sending usage of the first address segment to the control network element by using the sending module; or

periodically counting a quantity of terminal devices accessing the first DGW, and when determining that the first address segment cannot meet a requirement of the terminal device, sending new weight information to the control network element by using the sending module, so that the control network element re-assigns a new address segment to the first DGW.

The distributed gateway has a function for implementing an action of the distributed gateway in the foregoing method designs. The function may be implemented by hardware, or may be implemented by executing corresponding software by hardware. The hardware or software includes one or more modules corresponding to the foregoing function. The module may be software and/or hardware.

A fifth aspect of the present disclosure provides a communications system. The communications system includes:

the control network element according to any one of the third aspect or the possible designs of the third aspect; and

the distributed gateway according to any one of the fourth aspect or the possible designs of the fourth aspect.

Compared with the existing mechanism, in the present disclosure, the control network element assigns the first address segment to the first DGW according to the weight information of the first DGW, so that proper address segment assignment is implemented, and address resource utilization is improved.

### BRIEF DESCRIPTION OF DRAWINGS

FIG. 1 is a schematic flowchart of an address assignment method according to an embodiment;

FIG. 1-1 is another schematic flowchart of an address assignment method according to an embodiment;

FIG. 1-2 is another schematic flowchart of an address assignment method according to an embodiment;

FIG. 1-3 is another schematic flowchart of an address assignment method according to an embodiment;

FIG. 2 is a schematic structural diagram of a control network element according to an embodiment;

FIG. 3 is a schematic structural diagram of a distributed gateway according to an embodiment;

FIG. 4 is a schematic structural diagram of a communications system according to an embodiment;

FIG. 5 is another schematic structural diagram of a control network element according to an embodiment; and

FIG. 6 is another schematic structural diagram of a distributed gateway according to an embodiment.

### DESCRIPTION OF EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person skilled in the art based on the embodiments of the present disclosure without creative efforts shall fall within the protection scope of the present disclosure.

In the specification, claims, and accompanying drawings of the present disclosure, the terms “first”, “second”, and so on are intended to distinguish between similar objects but do not necessarily indicate a specific order or sequence. It should be understood that the data used in such a way is interchangeable in proper circumstances, so that the embodiments described herein can be implemented in other orders than the order illustrated or described herein. Moreover, the terms “include”, “contain” and any other variants mean to cover the non-exclusive inclusion, for example, a process, method, system, product, or device that includes a list of steps or modules is not necessarily limited to those expressly listed steps or modules, but may include other steps or modules not expressly listed or inherent to such a process, method, product, or device. The module division in this specification is merely logical division and may be other division in actual implementation. For example, a plurality of modules may be combined or integrated into another system, or some features may be ignored or not performed. In addition, the displayed or discussed mutual couplings or direct couplings or communication connections may be implemented by using some interfaces. The indirect couplings or communication connections between the modules may be implemented in electronic or other forms. This is not limited in this specification. In addition, the modules or submodules described as separate parts may or may not be physically separate, may or may not be physical modules, or may be distributed on a plurality of circuit modules. Some or all of the modules may be selected according to actual needs to achieve the objectives of the solutions of the embodiments in the present disclosure.

Embodiments of the present disclosure provide an address assignment method, a gateway, and a system, applied to the field of wireless communications technologies, so as to resolve a problem of relatively low resource utilization that is caused by improper address assignment in an existing mechanism.

Weight information in this specification refers to a quantity of resources required in a long period of time, and for example, may include current load, predicted load, or a user priority, or may be customized by a user.

In the existing mechanism, a mechanism for assigning an address segment to a DGW by a CGW is improper. To resolve this technical problem, the embodiments of the present disclosure mainly provide the following technical solution:

1. The CGW obtains weight information of a managed DGW.

2. The CGW assigns a corresponding address segment to the DGW according to the weight information of the DGW.

The CGW assigns the address segment according to the weight information of the DGW, so that an address resource can be properly assigned, and routing complexity in a network can be reduced.

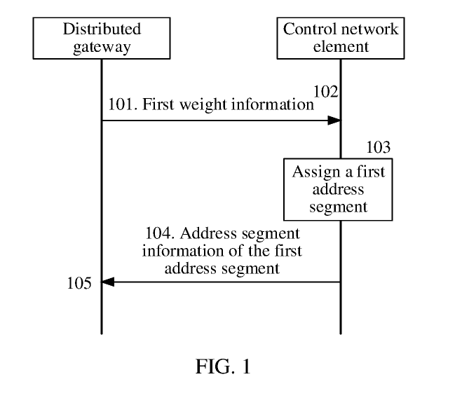

Referring to FIG. 1, an address assignment method in an embodiment of the present disclosure is described below. This embodiment of the present disclosure includes the following steps.

101. A first distributed gateway DGW sends first weight information of the first DGW to a control network element.

The first weight information is used by the control network element to assign a corresponding first address segment to the first DGW according to the first weight information.

102. The control network element obtains the first weight information of the first DGW.

The control network element obtains the first weight information in mainly the following two cases:

a. after the first DGW is started up and enters a working state, when the first DGW performs basic interaction with the control network element, the first DGW sends the first weight information to the control network element; and

b. in an attach procedure initiated by a terminal device, when the first DGW exchanges signaling with the control network element, the first DGW sends the first weight information to the control network element.

Optionally, the control network element may be a separate CGW, or may be a network element into which a CGW and an operation management (OM) entity are integrated, or may be a network element including two devices: a CGW and an OM entity that are independent of each other. A specific application scenario is not limited in this specification.

103. The control network element assigns a first address segment to the first DGW according to the first weight information.

104. The control network element sends address segment information of the first address segment to the first DGW.

105. The first DGW receives the address segment information of the first address segment that is returned by the control network element.

The address segment information of the first address segment includes an identifier of the first address segment. When the control network element includes a CGW and an OM entity, the first address segment is assigned by the OM entity to the first DGW according to the first weight information, the address segment information of the first address segment is sent by the OM entity to a Dynamic Host Configuration Protocol (DHCP) server, the identifier of the first address segment is obtained by the OM entity from the DHCP server, and the first weight information is obtained by the CGW from the first DGW.

Optionally, the identifier of the first address segment includes a proxy IP address of the DHCP server or a starting address of the first address segment. For example, in a scenario with a DHCP server, when the DHCP server provides an address assignment service to the outside, for a configured address segment, a proxy IP address is generally a starting address of the address segment. When receiving a DHCP request message sent by a terminal device, the DHCP server parses out a proxy IP address carried in the DHCP request message, to locate a corresponding address segment, selects an IP address from the address segment, encapsulates the IP address in a DHCP response message, and returns the DHCP response message to the terminal device that sends the DHCP request message.

In this embodiment of the present disclosure, the control network element assigns the first address segment to the first DGW according to the weight information of the first DGW, to implement proper address segment assignment, so that the DGW does not need to maintain a plurality of routing tables, thereby reducing routing complexity in a network, and improving address resource utilization.

Optionally, in some disclosure embodiments, after the control network element assigns the first address segment to the first DGW, in an attach procedure requested by a terminal device, the first DGW assigns an IP address to the terminal device, and details are as follows:

receiving, by the control network element, a first message sent by a mobility management entity (MME), where the first message is used to indicate that the terminal device requests to obtain an Internet Protocol IP address; and

obtaining, by the control network element, a destination IP address assigned by the first DGW to the terminal device, and returning, to the MME, a second message carrying the destination IP address.

Optionally, when the first DGW assigns an IP address to the terminal device, the first DGW needs to select the IP address from the first address segment assigned by the CGW to the first DGW. Because different quantities of terminal devices access the first DGW in different time periods, the first address segment has different assigned states. For example, at an early stage after the first DGW enters the working state, the first DGW has not assigned an address to a terminal device accessing the first DGW, or a relatively small quantity of terminal devices access the first DGW and remaining assignable address segments are relatively sufficient. Manners in which the first DGW assigns an IP address to a terminal device that newly accesses the first DGW mainly include the following two cases:

1. If it is the first time that the first DGW assigns an IP address to the terminal device after the first DGW is powered on, the control network element preferentially adds a starting address of the first address segment as the destination IP address to the second message, and returns the second message to the MME; and then the MME returns the destination IP address to UE. Optionally, an address randomly selected from the first address segment may be used as the destination IP address. A specific selection manner is not limited.

2. If it is not the first time that the first DGW assigns an IP address, the control network element sends a third message to the first DGW, where the third message is used to instruct the first DGW to assign the destination IP address to the terminal device; the first DGW returns, to the control network element, a fourth message carrying the destination IP address; after receiving the fourth message, the control network element returns, to the MME, the second message carrying the destination IP address; and then MME returns the destination IP address to UE. For a specific procedure, refer to FIG. 1-1.

Optionally, in some disclosure embodiments, in a scenario with a DHCP server, the control network element is responsible for assigning an address segment to the DGW, and the DHCP server provides only an IP address assignment function for the terminal device. An address resource pool of the DHCP server synchronously corresponds to an address resource pool of the control network element. For example, when there is a change in address segment assignment by the control network element, the change is synchronized to the DHCP server. To be specific, the control network element needs to control the DHCP server to assign an address segment to the DGW. Specifically, after assigning the first address segment to the first DGW, the control network element synchronizes address segment assignment information to the DHCP server, and synchronization signaling may be sent by the OM entity or the CGW. A process in which the control network element assigns the first address segment to the first DGW is as follows:

assigning, by the control network element, the first address segment to the first DGW according to the first weight information, and sending the address segment information of the first address segment to the Dynamic Host Configuration Protocol DHCP server, so that the DHCP server specifies the first address segment in the address resource pool according to the address segment information of the first address segment; and

obtaining, by the control network element, the identifier of the first address segment from the DHCP server, and sending the identifier of the first address segment to the first DGW.

Optionally, when the control network element includes the CGW and the OM entity, a process in which the control network element assigns the first address segment to the first DGW is as follows:

obtaining, by the CGW in the control network element, the first weight information of the first DGW, and sending the first weight information to the OM entity in the control network element;

assigning, by the OM entity in the control network element, the first address segment to the first DGW in the DHCP server according to the first weight information, and sending the identifier of the first address segment that is obtained from the DHCP server to the CGW; and

sending, by the CGW in the control network element, the received identifier of the first address segment to the first DGW, so that after receiving a second request message sent by the terminal device, the first DGW obtains, from the DHCP server according to the identifier of the first address segment, the destination IP address assigned to the terminal device, and returns the destination IP address to the terminal device.

Optionally, after the first address segment is assigned to the first DGW, the first DGW assigns the IP address to the terminal device, and mainly assigns the IP address to the terminal device in an attach procedure requested by the terminal device or a DHCP procedure requested by the terminal device.

Specifically, there are mainly the following two cases in which the IP address is assigned to the terminal device:

1. The IP address is assigned to the terminal device in the attach procedure requested by the terminal device.

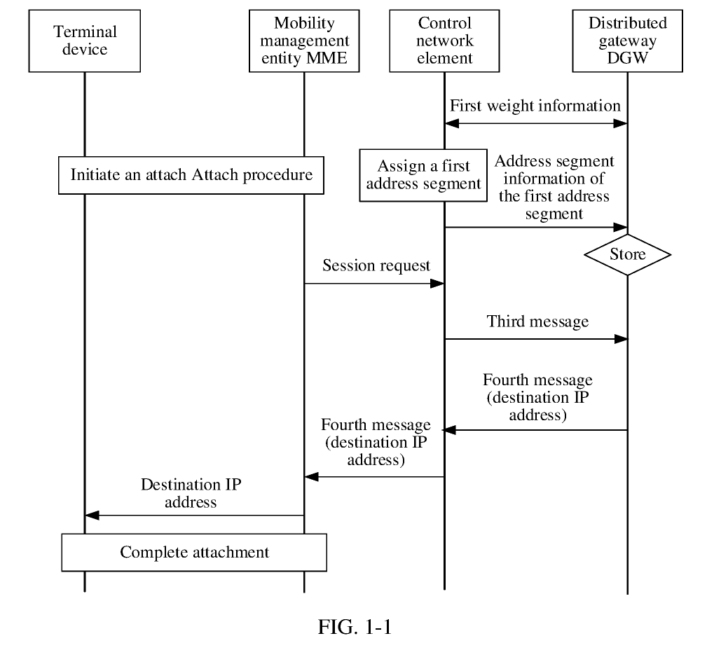

Referring to FIG. 1-2, the control network element obtains the identifier of the first address segment from the DHCP server, and after receiving a first request message sent by the MME, obtains, from the DHCP server according to the identifier of the first address segment, the destination IP address assigned to the terminal device, and returns the destination IP address to the MME; and then the MME returns the destination IP address to the terminal device.

2. The IP address is assigned to the terminal device in the DHCP procedure requested by the terminal device that is successfully attached.

Referring to FIG. 1-3, the control network element obtains the identifier of the first address segment from the DHCP server, and sends the identifier of the first address segment to the first DGW, so that after receiving a fifth message sent by the terminal device, the first DGW obtains, from the DHCP server according to the identifier of the first address segment, the destination IP address assigned to the terminal device, and returns the destination IP address to the terminal device.

Optionally, in some disclosure embodiments, the CGW can implement dynamic address segment assignment and dynamic address segment management according to information such as a current load status of the DGW, mainly for the following two cases:

I. An address segment is scheduled for a plurality of DGWs that have accessed the CGW.

The CGW manages a plurality of DGWs, and weight information of the DGWs may be different or there is a relatively large difference between weight information of the DGWs. Therefore, during initialization, address segments assigned by the CGW to the DGWs according to the weight information are different. However, as more terminal devices subsequently access some DGWs or address segments originally assigned to some DGWs become idle, in the present disclosure, the control network element may properly schedule the idle address segments according to an assignment status of the first address segment, to fully and properly use the idle address segments. Details are as follows:

When determining that there is an idle address segment in the first address segment, the control network element performs at least one of the following:

releasing the idle address segment; or

assigning the idle address segment to a DGW that is managed by the control network element and that has an urgent address requirement; or

re-assigning a new address segment to the first DGW according to address usage of the first DGW.

II. An address segment is scheduled for a plurality of DGWs that newly access the CGW.

1. After a period of time, when a new DGW accesses the CGW, the CGW needs to assign an address segment to the DGW that newly accesses the CGW. However, because an address segment may have been assigned, according to weight information, to a DGW that previously accesses the CGW, a remaining address segment in the address resource pool is insufficient to be assigned to the DGW that newly accesses the CGW, and in this period of time, address segments of some DGWs are idle, that is, are not fully used. Therefore, the idle address segment may be assigned to the DGW that newly accesses the CGW. Details are as follows:

obtaining, by the control network element, second weight information of a second DGW, and when determining that a remaining address segment resource in address segment resources is insufficient to assign an address segment corresponding to the second weight information, and there is the idle address segment in the first address segment, releasing the idle address segment in the first address segment, and assigning the idle address segment in the first address segment to the second DGW.

In this optional disclosure embodiment, in both the foregoing two cases, the CGW can implement dynamic address management, so that an address assignment mechanism is more proper, and address resource utilization is improved.

2. The control network element may determine, according to address usage of each managed DGW, whether to re-assign an address segment to the managed DGW or adjust address segments of some DGWs; or the control network element may re-assign, according to new weight information reported by a DGW, a new address segment to the DGW that provides the new weight information; or a DGW actively requests assignment of more address segments. In all the foregoing cases, dynamic address segment assignment can be implemented, load balancing uniformity can be improved, and resource utilization can be improved. The method further includes one of the following:

a. periodically sending, by the first DGW, usage of the first address segment to the control network element, so that the control network element periodically obtains usage of address segments of all managed DGWs, and when determining that a preset update triggering condition is satisfied, re-assigns new address segments to some or all of the managed DGWs according to the usage of the address segments of all the managed DGWs. For example, when determining that there is the idle address segment in the first address segment, the control network element releases the idle address segment, or assigns the idle address segment to the DGW that is managed by the control network element and that has an urgent address requirement, or re-assigns the new address segment to the first DGW according to the address usage of the first DGW;

b. obtaining, by the control network element, usage of address segments of all managed DGWs before a preset congestion time period is reached, and when determining that a preset update triggering condition is satisfied, re-assigning new address segments to some or all of the managed DGWs according to the usage of the address segments of all the managed DGWs;

c. sending, by the first DGW, a sixth message to the control network element, so that after receiving the sixth message, the control network element assigns a new address segment to the first DGW according to the sixth message; or

d. periodically counting, by the first DGW, a quantity of terminal devices accessing the first DGW, and when determining that the first address segment cannot meet a requirement of the terminal device, sending new weight information to the control network element, so that the control network element re-assigns a new address segment to the first DGW; and after obtaining the new weight information of the first DGW, re-assigning, by the control network element, the new address segment to the first DGW according to the new weight information.

Optionally, to avoid a problem that after the control network element is reset or recovered from a fault, an address segment before the fault cannot be recovered, each DGW needs to report usage of an address segment of the DGW to the CGW. That is, after the control network element is reset or recovered from the fault, the first DGW sends the usage of the first address segment to the control network element, and the control network element receives and stores the usage of the first address segment that is sent by the first DGW, so that the address segment before the resetting or recovery from the fault can be recovered.

The address assignment method in the present disclosure is described above, and a control network element and a distributed gateway that perform the address assignment method are described below by using examples.

I. Referring to FIG. 2, a control network element 20 is described. The control network element 20 includes:

a receiving module 201, configured to obtain first weight information of a first distributed gateway DGW;

a processing module 202, configured to assign a first address segment to the first DGW according to the first weight information received by the receiving module 201; and

a sending module 203, configured to send address segment information of the first address segment to the first DGW. Optionally, the address segment information of the first address segment includes an identifier of the first address segment, and the identifier of the first address segment includes a proxy IP address of the DHCP server or a starting address of the first address segment.

In this embodiment of the present disclosure, the processing module 202 assigns the first address segment to the first DGW according to the weight information of the first DGW obtained by the receiving module 201, to implement proper address segment assignment, so that the DGW does not need to maintain a plurality of routing tables, thereby reducing routing complexity in a network, and improving address resource utilization.

Optionally, in some disclosure embodiments, the receiving module 201 is further configured to: receive a first message sent by a mobility management entity MME, where the first message is used to indicate that a terminal device requests to obtain an Internet Protocol IP address; and obtain a destination IP address assigned by the first DGW to the terminal device; and

the sending module 203 is further configured to return, to the MME, a second message carrying the destination IP address obtained by the receiving module 201.

Optionally, in some disclosure embodiments, the processing module 202 is further configured to perform one of the following:

if it is the first time that the first DGW assigns an IP address to the terminal device after the first DGW is powered on, adding a starting address of the first address segment as the destination IP address to the second message, and returning the second message to the MME by using the sending module 203; or

if it is not the first time that the first DGW assigns an IP address, sending a third message to the first DGW by using the sending module 203, where the third message is used to instruct the first DGW to assign the destination IP address to the terminal device; and after receiving, by using the receiving module 201, a fourth message that is returned by the first DGW and that carries the destination IP address, returning, to the MME by using the sending module 203, the second message carrying the destination IP address.

Optionally, in some disclosure embodiments, the sending module 203 is further configured to:

send the address segment information of the first address segment to a Dynamic Host Configuration Protocol DHCP server, so that the DHCP server specifies the first address segment in an address resource pool according to the address segment information of the first address segment.

Optionally, in some disclosure embodiments, the processing module 202 is further configured to perform one of the following steps:

obtaining the identifier of the first address segment from the DHCP server by using the receiving module 201, and after receiving, by using the receiving module 201, a first request message sent by the MME, obtaining, from the DHCP server according to the identifier of the first address segment, the destination IP address assigned to the terminal device, and returning the destination IP address to the MME by using the sending module 203; or

obtaining the identifier of the first address segment from the DHCP server by using the receiving module 201, and sending the identifier of the first address segment to the first DGW by using the sending module 203, so that after receiving a fifth message sent by the terminal device, the first DGW obtains, from the DHCP server according to the identifier of the first address segment, the destination IP address assigned to the terminal device, and returns the destination IP address to the terminal device.

Optionally, in some disclosure embodiments, when determining that there is an idle address segment in the first address segment, the processing module 202 is further configured to perform at least one of the following:

releasing the idle address segment; or

assigning the idle address segment to a DGW that is managed by the control network element and that has an urgent address requirement; or

re-assigning a new address segment to the first DGW according to address usage of the first DGW.

Optionally, in some disclosure embodiments, the processing module 202 is further configured to:

obtain, by using the receiving module 201, second weight information of a second DGW, and when determining that a remaining address segment resource in address segment resources is insufficient to assign an address segment corresponding to the second weight information, and there is the idle address segment in the first address segment, release the idle address segment in the first address segment, and assign the idle address segment in the first address segment to the second DGW.

Optionally, in some disclosure embodiments, the processing module 202 is further configured to perform one of the following steps:

periodically obtaining, by using the receiving module 201, usage of address segments of all managed DGWs, and when determining that a preset update triggering condition is satisfied, re-assigning new address segments to some or all of the managed DGWs according to the usage of the address segments of all the managed DGWs;

obtaining, by using the receiving module 201, usage of address segments of all managed DGWs before a preset congestion time period is reached, and when determining that a preset update triggering condition is satisfied, re-assigning new address segments to some or all of the managed DGWs according to the usage of the address segments of all the managed DGWs;

receiving, by using the receiving module 201, a sixth message sent by the first DGW, and assigning a new address segment to the first DGW according to the sixth message;

obtaining, by using the receiving module 201, new weight information of the first DGW, and re-assigning a new address segment to the first DGW according to the new weight information; or

after the control network element is reset or recovered from a fault, receiving and storing, by using the receiving module 201, usage of the first address segment that is sent by the first DGW.

II. A first distributed gateway 30 is described. The first distributed gateway 30 includes:

a sending module 301, configured to send first weight information of the first distributed gateway DGW to a control network element, so that the control network element assigns a corresponding first address segment to the first DGW according to the first weight information; and

a receiving module 302, configured to receive address segment information of the first address segment that is returned by the control network element. Optionally, the address segment information of the first address segment includes an identifier of the first address segment, and the identifier of the first address segment includes a proxy IP address of the DHCP server or a starting address of the first address segment.

In this embodiment of the present disclosure, the sending module 301 sends the first weight information of the first DGW to the control network element, so that the control network element assigns the corresponding first address segment to the first DGW according to the first weight information, to implement proper address segment assignment, so that the DGW does not need to maintain a plurality of routing tables, thereby reducing routing complexity in a network, and improving address resource utilization.

Optionally, in some disclosure embodiments, the first distributed gateway 30 further includes:

a processing module 303, configured to: receive, by using the receiving module 302, a third message sent by the control network element, assign a destination IP address to a terminal device according to the third message, and send, to the control network element by using the sending module 301, a fourth message carrying the destination IP address, so that the control network element adds the destination IP address to a second message and returns the second message to a mobility management entity MME.

Optionally, in some disclosure embodiments, the processing module 303 is further configured to:

after receiving, by using the receiving module 302, a fifth message sent by the terminal device, obtain, from the DHCP server according to the identifier of the first address segment, the destination IP address assigned to the terminal device, and return the destination IP address to the terminal device by using the sending module 301.

Optionally, in some disclosure embodiments, the processing module 303 is further configured to perform one of the following:

periodically sending usage of the first address segment to the control network element by using the sending module 301, so that when determining that there is an idle address segment in the first address segment, the control network element releases the idle address segment, or assigns the idle address segment to a DGW that is managed by the control network element and that has an urgent address requirement, or re-assigns a new address segment to the first DGW according to address usage of the first DGW;

sending, by using the sending module 301, a sixth message to the control network element, where the sixth message is used to request the control network element to assign a new address segment to the first DGW;

after the control network element is reset or recovered from a fault, sending usage of the first address segment to the control network element by using the sending module 301; or

periodically counting a quantity of terminal devices accessing the first DGW, and when determining that the first address segment cannot meet a requirement of the terminal device, sending new weight information to the control network element by using the sending module 301, so that the control network element re-assigns a new address segment to the first DGW.

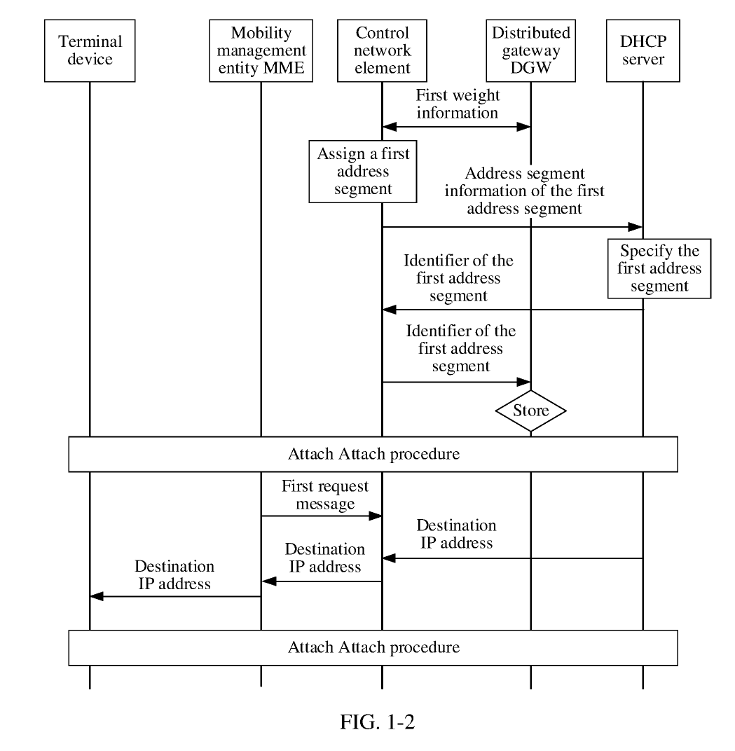

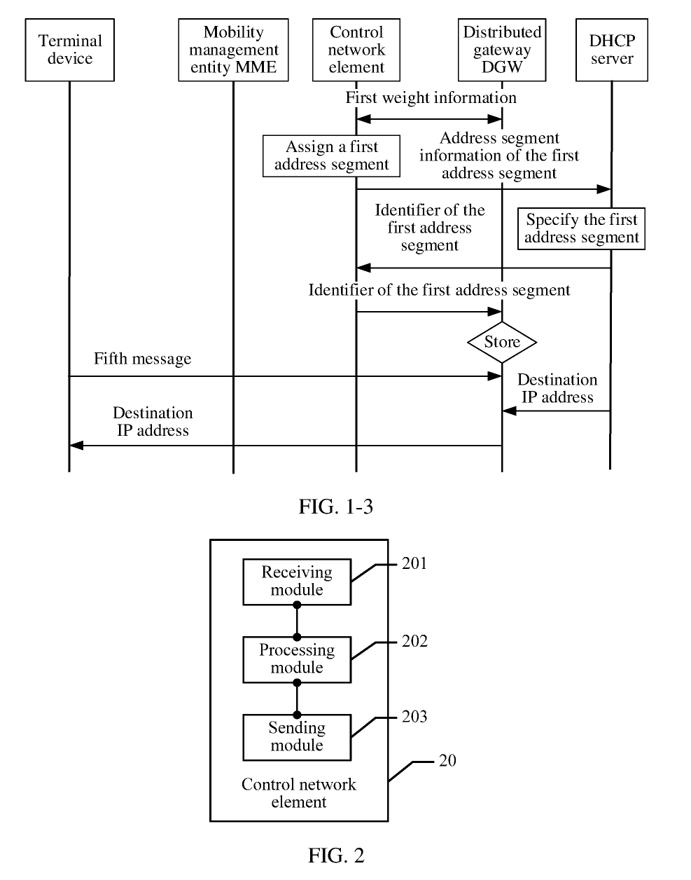

In the embodiments of the present disclosure, all physical devices corresponding to the receiving modules in FIG. 2 and FIG. 3 are receivers, all physical devices corresponding to the sending modules in FIG. 2 and FIG. 3 are transmitters, and all physical devices corresponding to the processing modules in FIG. 2 and FIG. 3 are processors.

III. A communications system 40 in the present disclosure is described. The communications system 40 includes:

the control network element shown in FIG. 2 and the distributed gateway shown in FIG. 3.

The present disclosure further provides a computer storage medium. The medium stores a program, and when the program is executed, some or all of the steps of the foregoing address assignment method performed by the foregoing control network element or the foregoing distributed gateway are included.

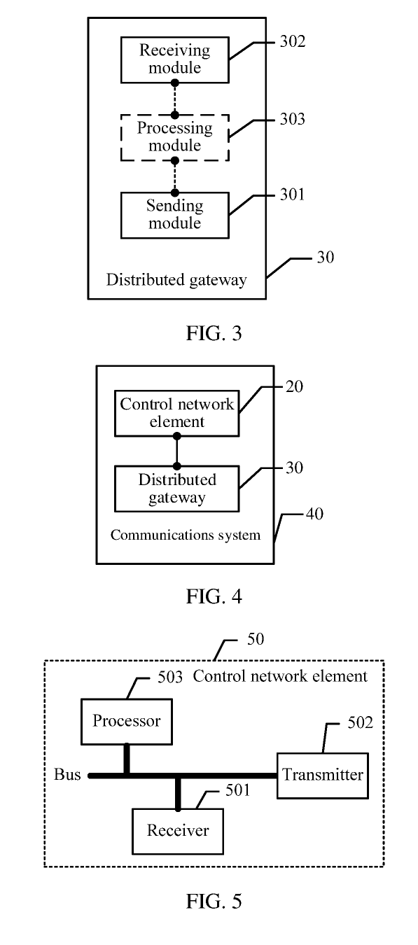

FIG. 5 is another schematic structural diagram of a control network element 50 according to an embodiment of the present disclosure. The control network element 50 may include at least one network interface or another communications interface, at least one receiver 501, at least one transmitter 502, at least one processor 503, and a memory 504, to implement connection and communication between these apparatuses. Communication connections between a system gateway and at least one other network element are implemented by using the at least one network interface (which may be a wired network interface or a wireless network interface). The Internet, a wide area network, a local area network, a metropolitan area network, or the like may be used.

The memory 504 may include a read-only memory and a random access memory, and provide an instruction and data to the processor 503. Apart of the memory 504 may further include a high-speed random access memory (RAM), or may further include a non-volatile memory.

The memory 504 stores the following elements, executable modules or data structures, or a subset thereof, or an extension set thereof:

operation instructions, including various operation instructions and used to perform various operations; and

an operating system, including various system programs and used to implement various basic services and process a hardware-based task.

In this embodiment of the present disclosure, the processor 503 performs the following operations by invoking the operation instructions (the operation instructions may be stored in the operating system) stored in the memory 504:

obtaining first weight information of a first distributed gateway DGW by using the receiver 501;

assigning a first address segment to the first DGW according to the first weight information received by the receiver 501; and

sending address segment information of the first address segment to the first DGW by using the transmitter 502.

In some implementations, the processor 503 may further perform the following steps:

receiving, by using the receiver 501, a first message sent by a mobility management entity MME, where the first message is used to indicate that a terminal device requests to obtain an Internet Protocol IP address; and obtaining a destination IP address assigned by the first DGW to the terminal device; and

returning, to the MME by using the transmitter 502, a second message carrying the destination IP address obtained by the receiver 501.

In some implementations, the processor 503 may further perform one of the following steps:

if it is the first time that the first DGW assigns an IP address to the terminal device after the first DGW is powered on, adding a starting address of the first address segment as the destination IP address to the second message, and returning the second message to the MME by using the transmitter 502; or

if it is not the first time that the first DGW assigns an IP address, sending a third message to the first DGW by using the transmitter 502, where the third message is used to instruct the first DGW to assign the destination IP address to the terminal device; and after receiving, by using the receiver 501, a fourth message that is returned by the first DGW and that carries the destination IP address, returning, to the MME by using the transmitter 502, the second message carrying the destination IP address.

In some implementations, the processor 503 may further perform the following step:

sending, by using the transmitter 502, the address segment information of the first address segment to a Dynamic Host Configuration Protocol DHCP server, so that the DHCP server specifies the first address segment in an address resource pool according to the address segment information of the first address segment.

In some implementations, the processor 503 may further perform at least one of the following steps:

obtaining an identifier of the first address segment from the DHCP server by using the receiver 501, and after receiving, by using the receiver 501, a first request message sent by the MME, obtaining, from the DHCP server according to the identifier of the first address segment, the destination IP address assigned to the terminal device, and returning the destination IP address to the MME by using the transmitter 502; or

obtaining an identifier of the first address segment from the DHCP server by using the receiver 501, and sending the identifier of the first address segment to the first DGW by using the transmitter 502, so that after receiving a fifth message sent by the terminal device, the first DGW obtains, from the DHCP server according to the identifier of the first address segment, the destination IP address assigned to the terminal device, and returns the destination IP address to the terminal device.

In some implementations, when determining that there is an idle address segment in the first address segment, the processor 503 may further perform at least one of the following steps:

releasing the idle address segment; or

assigning the idle address segment to a DGW that is managed by the control network element and that has an urgent address requirement; or

re-assigning a new address segment to the first DGW according to address usage of the first DGW.

In some implementations, the processor 503 may further perform the following step:

obtaining, by using the receiver 501, second weight information of a second DGW, and when determining that a remaining address segment resource in address segment resources is insufficient to assign an address segment corresponding to the second weight information, and there is the idle address segment in the first address segment, releasing the idle address segment in the first address segment, and assigning the idle address segment in the first address segment to the second DGW.

In some implementations, the processor 503 may further perform at least one of the following steps:

periodically obtaining, by using the receiver 501, usage of address segments of all managed DGWs, and when determining that a preset update triggering condition is satisfied, re-assigning new address segments to some or all of the managed DGWs according to the usage of the address segments of all the managed DGWs;

obtaining, by using the receiver 501, usage of address segments of all managed DGWs before a preset congestion time period is reached, and when determining that a preset update triggering condition is satisfied, re-assigning new address segments to some or all of the managed DGWs according to the usage of the address segments of all the managed DGWs;

receiving, by using the receiver 501, a sixth message sent by the first DGW, and assigning a new address segment to the first DGW according to the sixth message;

obtaining, by using the receiver 501, new weight information of the first DGW, and re-assigning a new address segment to the first DGW according to the new weight information; or

after the control network element is reset or recovered from a fault, receiving and storing, by using the receiver 501, usage of the first address segment that is sent by the first DGW.

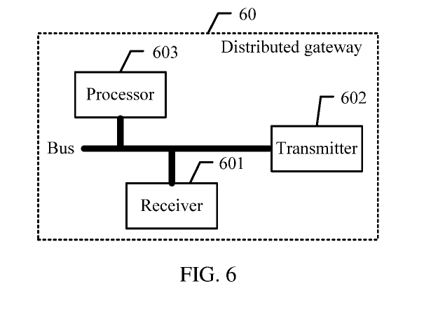

FIG. 6 is another schematic structural diagram of a distributed gateway 60 according to an embodiment of the present disclosure. The distributed gateway 60 may include at least one network interface or another communications interface, at least one receiver 601, at least one transmitter 602, at least one processor 603, and a memory 604, to implement connection and communication between these apparatuses. Communication connections between the system gateway and at least one other network element are implemented by using the at least one network interface (which may be a wired network interface or a wireless network interface). The Internet, a wide area network, a local area network, a metropolitan area network, or the like may be used.

The memory 604 may include a read-only memory and a random access memory, and provide an instruction and data to the processor 603. Apart of the memory 604 may further include a high-speed random access memory (RAM), or may further include a non-volatile memory.

The memory 604 stores the following elements, executable modules or data structures, or a subset thereof, or an extension set thereof:

operation instructions, including various operation instructions and used to perform various operations; and

an operating system, including various system programs and used to implement various basic services and process a hardware-based task.

In this embodiment of the present disclosure, the processor 603 performs the following operations by invoking the operation instructions (the operation instructions may be stored in the operating system) stored in the memory 604:

sending first weight information of the first distributed gateway DGW to a control network element by using the transmitter 602, so that the control network element assigns a corresponding first address segment to the first DGW according to the first weight information; and

receiving, by using the receiver 601, address segment information of the first address segment that is returned by the control network element. Optionally, the address segment information of the first address segment includes an identifier of the first address segment, and the identifier of the first address segment includes a proxy IP address of the DHCP server or a starting address of the first address segment.

In some implementations, the processor 603 may further perform the following step:

receiving, by using the receiver 601, a third message sent by the control network element, assigning a destination IP address to a terminal device according to the third message, and sending, to the control network element by using the receiver 601, a fourth message carrying the destination IP address, so that the control network element adds the destination IP address to a second message and returns the second message to a mobility management entity MME.

In some implementations, the processor 603 may further perform the following step:

after receiving, by using the receiver 601, a fifth message sent by the terminal device, obtaining, from the DHCP server according to the identifier of the first address segment, the destination IP address assigned to the terminal device, and returning the destination IP address to the terminal device by using the receiver 601.

In some implementations, the processor 603 may further perform one of the following steps:

periodically sending usage of the first address segment to the control network element by using the transmitter 602, so that when determining that there is an idle address segment in the first address segment, the control network element releases the idle address segment, or assigns the idle address segment to a DGW that is managed by the control network element and that has an urgent address requirement, or re-assigns a new address segment to the first DGW according to address usage of the first DGW;

sending a sixth message to the control network element by using the transmitter 602, where the sixth message is used to request the control network element to assign a new address segment to the first DGW;

after the control network element is reset or recovered from a fault, sending usage of the first address segment to the control network element by using the transmitter 602; or

periodically counting a quantity of terminal devices accessing the first DGW, and when determining that the first address segment cannot meet a requirement of the terminal device, sending new weight information to the control network element by using the transmitter 602, so that the control network element re-assigns a new address segment to the first DGW.

In the foregoing embodiments, the description of each embodiment has respective focus. For a part that is not described in detail in an embodiment, refer to related descriptions in other embodiments.

It may be clearly understood by a person skilled in the art that, for the purpose of convenient and brief description, for a detailed working process of the foregoing system, apparatus, and unit, refer to a corresponding process in the foregoing method embodiments, and details are not described herein.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. Indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The address assignment method and the gateway provided in the present disclosure are described in detail above. In this specification, specific examples are used to describe the principle and implementations of the present disclosure, and the description of the embodiments is only intended to help understand the method and core idea of the present disclosure. Meanwhile, a person of ordinary skill in the art may, based on the idea of the present disclosure, make modifications with respect to the specific implementations and the application scope. Therefore, the content of this specification shall not be construed as a limitation to the present disclosure.

What is claimed is:

1. An address assignment method, the method comprising:
obtaining, by a control network element, first weight information of a first distributed gateway (DGW), and assigning a first address segment to the first DGW according to the first weight information; and
sending, by the control network element, address segment information of the first address segment to the first DGW.

2. The method according to claim 1, further comprising:
receiving, by the control network element, a first message sent by a mobility management entity (MME) for indicating that a terminal device requests to obtain an Internet Protocol (IP) address; and
obtaining, by the control network element, a destination IP address assigned by the first DGW to the terminal device, and returning, to the MME, a second message carrying the destination IP address.

3. The method according to claim 2, wherein obtaining, by the control network element, the destination IP address assigned by the first DGW to the terminal device, and returning, to the MME, the second message carrying the destination IP address comprises one of the following:
when it is the first time that the first DGW assigns an IP address to the terminal device after the first DGW is powered on:
adding, by the control network element, a starting address of the first address segment as the destination IP address to the second message, and
returning the second message to the MME; and
when it is not the first time that the first DGW assigns an IP address:
sending, by the control network element, a third message to the first DGW for instructing the first DGW to assign the destination IP address to the terminal device, and
after receiving a fourth message that is returned by the first DGW and that carries the destination IP address, returning, by the control network element to the MME, the second message carrying the destination IP address.

4. The method according to claim 1, wherein:
the address segment information of the first address segment comprises an identifier of the first address segment; and
after assigning the first address segment to the first DGW according to the first weight information, the method further comprises:
sending, by the control network element, the address segment information of the first address segment to a Dynamic Host Configuration Protocol (DHCP) server for enabling the DHCP server to specify the first address segment in an address resource pool according to the address segment information of the first address segment.

5. The method according to claim 4, further comprising one of the following:
obtaining, by the control network element, the identifier of the first address segment from the DHCP server, and after receiving a first request message sent by the MME, obtaining, from the DHCP server according to the identifier of the first address segment, the destination IP address assigned to the terminal device, and returning the destination IP address to the MME; and
obtaining, by the control network element, the identifier of the first address segment from the DHCP server, and sending the identifier of the first address segment to the first DGW, so that after receiving a fifth message sent by the terminal device, the first DGW obtains, from the DHCP server according to the identifier of the first address segment, the destination IP address assigned to the terminal device, and returns the destination IP address to the terminal device.

6. The method according to claim 1, wherein the identifier of the first address segment comprises a proxy IP address of the DHCP server or a starting address of the first address segment.

7. An address assignment method, the method comprising:
sending, by a first distributed gateway (DGW), first weight information of the first DGW to a control network element for enabling the control network element to assign a corresponding first address segment to the first DGW according to the first weight information; and
receiving, by the first DGW, address segment information of the first address segment that is returned by the control network element.

8. The method according to claim 7, further comprising:
receiving, by the first DGW, a third message sent by the control network element;
assigning a destination IP address to a terminal device according to the third message; and
sending, to the control network element, a fourth message carrying the destination IP address for enabling the control network element to add the destination IP address to a second message and return the second message to a mobility management entity (MME).

9. The method according to claim 7, further comprising:
after receiving a fifth message sent by the terminal device, obtaining, by the first DGW from the DHCP server according to an identifier of the first address segment, the destination IP address assigned to the terminal device, and returning the destination IP address to the terminal device.

10. The method according to claim 7, wherein the address segment information of the first address segment comprises the identifier of the first address segment, and the identifier of the first address segment comprises a proxy IP address of the DHCP server or a starting address of the first address segment.

11. A control network element, wherein the control network element comprises:
a receiver, configured to obtain first weight information of a first distributed gateway (DGW);
a processor, configured to assign a first address segment to the first DGW according to the first weight information received by the receiver; and
a transmitter, configured to send address segment information of the first address segment to the first DGW.

12. The control network element according to claim 11, wherein:
the receiver is further configured to:
receive a first message sent by a mobility management entity (MME) for indicating that a terminal device requests to obtain an Internet Protocol (IP) address, and
obtain a destination IP address assigned by the first DGW to the terminal device; and
the transmitter is further configured to return, to the MME, a second message carrying the destination IP address obtained by the receiver.

13. The control network element according to claim 12, wherein the processor is further configured to:
when it is the first time that the first DGW assigns an IP address to the terminal device after the first DGW is powered on:
add a starting address of the first address segment as the destination IP address to the second message, and
return the second message to the MME by using the transmitter; and
when it is not the first time that the first DGW assigns an IP address:
send a third message to the first DGW by using the transmitter for instructing the first DGW to assign the destination IP address to the terminal device, and
after receiving, by using the receiver, a fourth message that is returned by the first DGW and that carries the destination IP address, return, to the MME by using the transmitter, the second message carrying the destination IP address.

14. The control network element according to claim 11, wherein the address segment information of the first address segment comprises an identifier of the first address segment, and the transmitter is further configured to:
send the address segment information of the first address segment to a Dynamic Host Configuration Protocol (DHCP) server for enabling the DHCP server to specify the first address segment in an address resource pool according to the address segment information of the first address segment.

15. The control network element according to claim 14, wherein the processor is further configured to:
obtain the identifier of the first address segment from the DHCP server by using the receiver, and after receiving, by using the receiver, a first request message sent by the MME, obtain, from the DHCP server according to the identifier of the first address segment, the destination IP address assigned to the terminal device, and return the destination IP address to the MME by using the transmitter; or
obtain the identifier of the first address segment from the DHCP server by using the receiver, and send the identifier of the first address segment to the first DGW by using the transmitter to enable the first DGW to obtain, from the DHCP server according to the identifier of the first address segment and after the first DGW receives a fifth message sent by the terminal device, the destination IP address assigned to the terminal device, and return the destination IP address to the terminal device.

16. The control network element according to claim 11, wherein the identifier of the first address segment comprises a proxy IP address of the DHCP server or a starting address of the first address segment.

17. A first distributed gateway (DGW), wherein the first DGW comprises:
a transmitter, configured to send first weight information of the first distributed gateway to a control network element for enabling the control network element to assign a corresponding first address segment to the first DGW according to the first weight information; and
a receiver, configured to receive address segment information of the first address segment that is returned by the control network element.

18. The distributed gateway according to claim 17, wherein the first distributed gateway further comprises:
a processor, configured to:
receive, by using the receiver, a third message sent by the control network element,
assign a destination IP address to a terminal device according to the third message, and
send, to the control network element by using the transmitter, a fourth message carrying the destination IP address for enabling the control network element to add the destination IP address to a second message and returns the second message to a mobility management entity (MME).

19. The distributed gateway according to claim 17, wherein the processor is further configured to:
after receiving, by using the receiver, a fifth message sent by the terminal device, obtain, from a DHCP server according to an identifier of the first address segment, the destination IP address assigned to the terminal device, and return the destination IP address to the terminal device by using the transmitter.

20. The distributed gateway according to claim 17, wherein the address segment information of the first address segment comprises the identifier of the first address segment, and the identifier of the first address segment comprises a proxy IP address of the DHCP server or a starting address of the first address segment.
